(19) United States
(12) Patent Application Publication
(10) Pub. No.: US 2009/0162594 A1
(43) Pub. Date: Jun. 25, 2009

(54) Method and apparatus for motion capture marker

(76) Inventor: Sean Stanek, Burbank, CA (US)

Correspondence Address: Sean Stanek, 4412 W. Jacaranda Ave., Burbank, CA, 91505, US

(21) Appl. No.: 12/229,221

(22) Filed: Aug. 20, 2008

Related U.S. Application Data
(60) Provisional application No. 60/965,181, filed on Aug. 20, 2007.

(51) Int. Cl. B32B 33/00; B32B 38/10

(52) U.S. Cl. 428/41.7; 156/289

(57) ABSTRACT

The invention provides a product referred to as a marker for marking body locations and a method of fabricating and using such a marker in order to capture motion data in a video motion capture settings. The marker allows for easy attachment to a body location and easy removal without requiring long preparation of location on the body to attach a marker. The marker comprise a protective sheet removeably attached to the marker. The removal of such protective piece uncovers a surface having adhering properties. The adhering surface is then pressed against the body which results in securing the marker on a given location.

### FIELD OF THE INVENTION

The invention relates to a method and apparatus for removeably attaching light reflecting markers utilized for capturing motion data in the film industry.

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND OF THE INVENTION

In the motion picture industry, such as in movie and video game production, one method used to generate live-like movements of computer generated animations involves capturing live movement data which are then incorporated in the computer generation process. The method relies on attaching a light reflecting device, to which it is typically referred as a marker, at several distinguishing body areas, then one or more cameras capture the position information of each marker at successive intervals of time and stores it on a computer. For example, using the latter method the movement of an actor can be captured and then later applied to the motions of a (three-dimensional) computer-generated character. In another example, using the latter method, several markers may be attached to an actor's face in order to capture facial movements which can be characteristic of and associated with emotional expressions allowing a computer generated character to be animated with facial expressions.

In the existing method for motion capture, a marker is typically a small ball that is covered with a reflective material to reflect light. To attach makers to body parts (e.g., face, hands, fingers etc.), the markers are glued to the actor's body using several different grade glues. Applying the markers as described above has many drawbacks, including that it is time consuming, very uncomfortable for the actor, and hard to remove. For example, the glue has to be first applied and then a small fan unit is needed to dry the glue until it gets tacky, before the marker is adhered to the body. Another problem with the existing method of adhering a marker to an actor's body is the shortness of the life of the glue. An actor may perspire while acting, leading to the falling off of the markers. When a marker falls off, a makeup person has to then reapply the glue, fan the glue until it gets tacky, and then re-apply the marker. This wastes valuable time and money during production. Furthermore, once the motion capture session is finished the glue has to be removed and the skin cleaned. The glue left behind on the actor's body is often very difficult to remove without irritating the skin, since a solvent is generally required to achieve the desired cleanliness.

Therefore, there is a need to shorten the time to prepare an actor with markers and ease the removal of markers off of the body. The invention is a method and device that address the latter mentioned issues with utilizing a marker for motion capture.

### SUMMARY OF THE INVENTION

The invention addresses a particular need for saving time and the complexity of using markers during filming of actors in order to capture body motion data. In order to capture body motion data, an actor is fitted with a set of markers that are strategically positioned at several body location to capture data associated with a given type motion.

The invention discloses a novel type of marker having a reflective side that provides the optical requirement for light capture, and an adhering side allowing easy attachment to a body location and easy removal of the marker when its use is finished. In order to fit a marker made in accordance with the invention onto the body, a protective piece is peeled away from the adhering side of the marker, thus uncovering a surface capable of adhering to the body. Then, the marker may simply be pressed against the body in order to secure at a given body location.

### DESCRIPTION OF THE DRAWINGS

FIG. 1 and FIG. 2 depict the process by which a reflective sheet is combined with a support element to fabricate a portion of a marker in accordance with an embodiment of the invention.

FIG. 3 depicts an optional step in the process of fabricating a marker in accordance with an embodiment of the invention.

FIG. 4 further depicts a step of attaching an adhesive sheet to the previously fabricated portion of the marker in accordance with an embodiment of the invention.

FIG. 5 depicts the assembled components in the process of fabricating a marker following the process steps as described in FIGS. 1 through 4 in accordance with an embodiment of the invention.

FIG. 6 depicts an optional final step of trimming the marker to desired size and/or shape in accordance with an embodiment of the invention.

FIG. 7 depicts an exploded view of marker fabricated in accordance with an embodiment of the invention.

FIG. 8 depicts the method by which the backing of the marker is peeled away from the marker in accordance with an embodiment of the invention.

FIG. 9 depicts a method of use of the marker on an actor's face in accordance with an embodiment of the invention.

### DETAILED DESCRIPTION OF THE INVENTION

An embodiment of the invention is a method and apparatus for removeably attaching a marker onto an actors body in order to capture body motion data during film production.

In the following description, numerous specific details are set forth to provide a more thorough description of the invention. It will be apparent, however, to one skilled in the pertinent art, that the invention may be practiced without these specific details. In other instances, well known features have not been described in detail so as not to obscure the invention. The claims following this description are what define the metes and bounds of the invention.

In an embodiment of the invention, the marker comprises a support element The support element may be a piece of silicone rubber, plastic of any other material that may be suited for fabricating a marker. The support element is preferably made of a malleable material that lends itself to be easily cut and shaped to best fit any desired size and/or shape. The support element is generally spherically shaped. For example, the marker may be a half-sphere wherein the flat base area is destined to be used as a contact against the body and the protruding surface area is destined to support a light emitting area captured by cameras.

The reflective material used to fabricate a device implementing the invention may be any available material capable of reflecting light and/or producing the optical effect (e.g., fluorescence) that enable the marker to be visible under special and/or desired circumstances. The choice of any specific reflective material is dictated by the end-goal of the marker. For example, when infrared or visible light is utilized to shine onto the marker in order to capture the motion, the reflective material is selected of its property to reflect light accordingly in the infrared or the visible light wave length. In other situations, such as when a dark light (e.g., ultra-violet light) is utilized to shine onto the marker, whereas the camera captures visible light, a material equipped with one or more fluorescent dyes is more suitable for the desired application.

A device embodying the invention may utilize a reflective tape from 3M® Scotchlite™ product line that comprises a number of reflective tape models. A device implementing the invention may also utilize a reflective paint. The latter type of paint typically comprises one or more dyes or reflective substance that allow a surface painted with such paint to reflect light with a high yield of reflection and/or emit fluorescent light. Using the latter type of paint, the paint may be directly applied onto the support element of the device implementing the invention or otherwise applied to a sheet of solid material (e.g., plastic sheet) which is then securely attached (e.g., glued) to the support element.

In a device implementing the invention, the side of the marker destined to come in contact with the skin comprises a layer of adhesive material such that when pressed against the body it allows the marker to securely hold on to the body. The adhesive material is designed such that when removed all or most of it may not remain on the body. Compounds known to possess such adhesive properties are well known and used in the medical field. Most first aid bandages nowadays are of the type that allows a bandage to stick to the skin, and eventually reattach even after it has been removed one or more times, without loosing the adhesiveness. These compounds further posses a property of coming off of the skin when removed without leaving any significant amount on the skin. For example, first aid bandages Band-Aid® from Johnson&Johnson Co. utilize an adhesive that possess properties enabling a device implementing the invention.

The adhesive may be applied directly to the support element described above. However, the adhesive may be instead applied to a sheet that is in turn securely attached to the support element.

Finally, a protective sheet may be utilized to protect the adhesive until the marker is to be used. At which time a user may remove the protective sheet and position the marker onto the body.

The following figures schematically depict a method of fabrication of a device implementing the invention, and a method of use of the device.

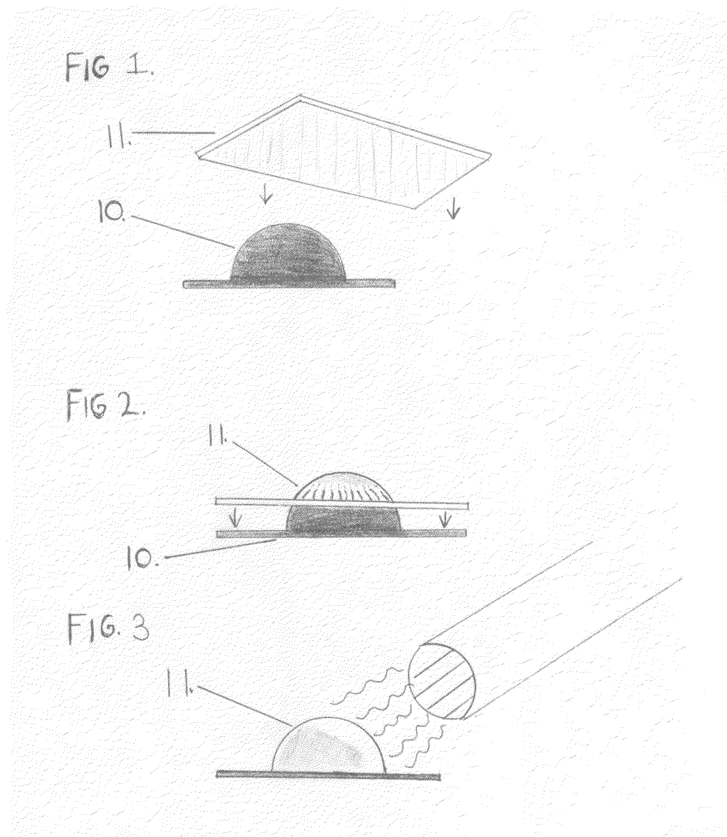

FIG. 1 and FIG. 2 depict the process by which a reflective sheet is combined with a support element to fabricate a portion of a marker in accordance with an embodiment of the invention. A sheet of reflect material 11 may be pressed onto a support element 10. The support element is a half sphere comprised of a silicone rubber. The reflective material as shown in FIGS. 1 and 2 may be initially cut to cover a surface larger than the support element.

FIG. 3 depicts an optional step in the process of fabricating a marker in accordance with an embodiment of the invention. The reflective material, such a reflective tape, and/or the support element material may require further heating these element to bond or further improve the bonding of the element to each other. In the instance depicted in FIG. 3, heat is applied to shrink the reflective material 11 onto the support element 10.

FIG. 4 further depicts a step of attaching an adhesive sheet to the previously fabricated portion of the marker in accordance with an embodiment of the invention. In FIG. 4, the combination of reflective material 11 and support element 10 is adhered to an adhesive film backing 12 (e.g., self adhesive element). The backing may be, for example, be have a wax paper type material capable of being peeled away to expose the adhesive film.

FIG. 5 depicts the assembled components in the process of fabricating a marker following the process steps as described in FIGS. 1 through 4 in accordance with an embodiment of the invention. In FIG. 5 the reflective portion 11, the support element 10 and the self adhesive element 12 are securely assembled in one piece.

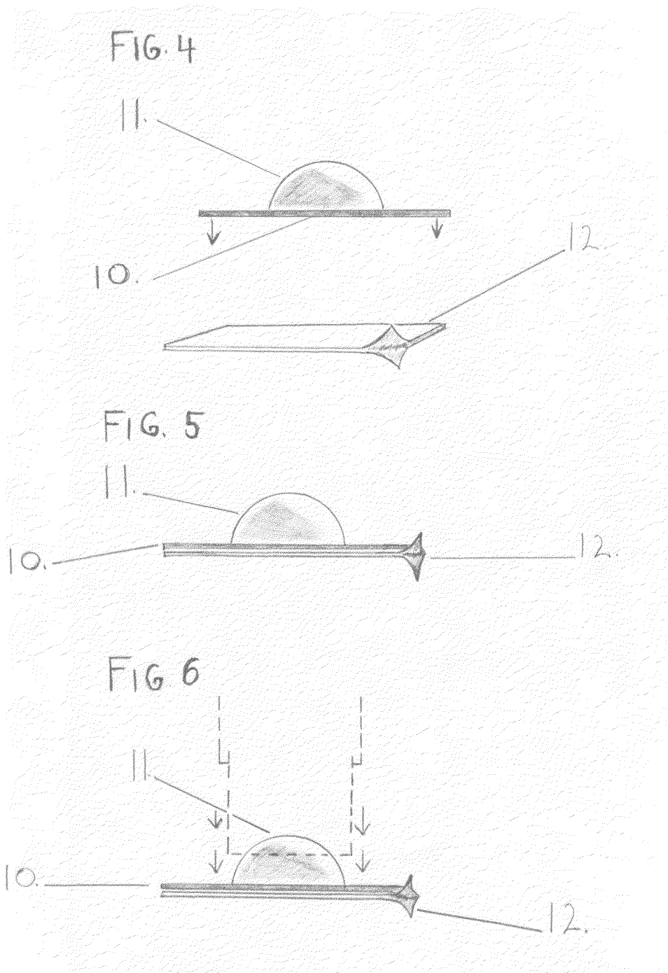

FIG. 6 depicts an optional final step of trimming the marker to desired size and/or shape in accordance with an embodiment of the invention. In FIG. 6, a machine punch may be utilized to trim the surrounding rubber silicone base 10 and leave a clean half sphere with the adhesive backing adhered to its base. The machine punch may be configured to cut a marker in a given configuration in order to supply a desired shape for a specific need.

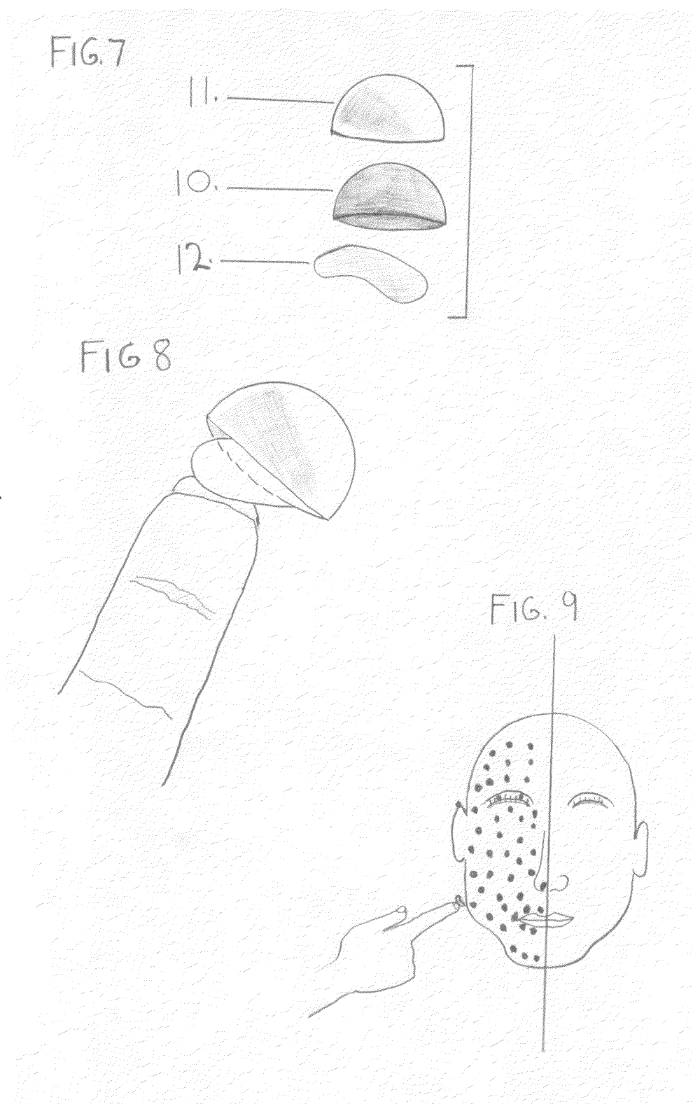

FIG. 7 depicts an exploded view of marker fabricated in accordance to an embodiment of the invention. The device depicted in FIG. 7 comprises a reflective tape element 11, a clean silicone rubber half sphere 10 and a base adhesive film backing 12.

FIG. 8 depicts the method by which the backing of the marker is peeled away from the marker in accordance with an embodiment of the invention. Because the invention discloses using a protective sheet that preserves the adhesiveness of the base of the marker while allowing the protective sheet to be easily removed, a user may use a finger or a small tool such as tweezers to remove the protective sheet from the marker.

FIG. 9 depicts a method of use of the marker on an actor's face in accordance with an embodiment of the invention. The adhesive film is peeled and applied to the actor's skin on the face in the example schematically depicted in FIG. 9. Marker size varies as well as quantity used. Predicated on animation application.

Thus, an apparatus for marking an body location to facilitate capture of body motion data, and a method for fabricating and using the apparatus are disclosed.

The claimed invention is:

1. A product comprising:
means for reflecting light;
means for support having a first and a second support sides, wherein said means for reflecting light is secured to said first support side;
means for attaching having a first and a second adhering sides, wherein said first adhering side is attached to said second support side; and
means for protecting comprising a peelable element, wherein said peelable element is removeably attached to said second adhering side for temporarily preserving the adhesiveness of said second adhering side.

2. A method comprising:
obtaining a marker having a light reflective surface and at least one peelable preserving element;
removing said peelable element, wherein said removing uncovers a sticky surface; and
applying said sticky surface to at least one body area for removeably positioning said marker onto a body location.
